(19) United States
(12) Patent Application Publication
(10) Pub. No.: US 2013/0167325 A1
(43) Pub. Date: Jul. 4, 2013

(54) DEVICE FOR SWIVELING A DISK

(71) Applicant: Dieter Hackenberg, Witten (DE)

(72) Inventor: Dieter Hackenberg, Witten (DE)

(21) Appl. No.: 13/805,384

(22) PCT Filed: Jun. 30, 2010
(86) PCT No.: PCT/EP2010/003953

§ 371 Date: Dec. 19, 2012

(51) Int. Cl. E05F 1/12

(52) U.S. Cl. CPC E05F 1/12
USPC 16/302

(57) ABSTRACT

The invention relates to a device for swiveling a disk (11), in particular on a counter (10), such as a refrigerated display case, sales counter, or self-service counter. A stationery bearing part (15) is provided for a joint part (20) supported thereon in such a way that the joint part can be swiveled. The joint part bears the disk (11) and has a substantially horizontal swivel axis (12). The disk (11) can be swiveled about the swivel axis between a lowered position (11.1) and a raised position (11.2) in a substantially vertical swivel plane (13). At least one energy accumulator (30) having connection ends (31, 32) is used as a lifting aid for raising the disk (11).

The invention relates to an apparatus for pivoting movement of a disk of the type recited in the preamble of claim 1. Such devices typically are found used at bar counters, in particular with refrigerator, sales, or self-service counters. The goods are thereby offered in the interior of the bar counter and are made visible for potential customers by the use of a transparent plate. For loading or cleaning of the counter, the counter needs to be made easily accessible to the operating personnel. In particular when used in the food industry, good and simple hygienic cleaning is very important. The plate is rotated about a horizontal axis in order to make the interior of the counter available to the operating personnel. This way the plate can be brought out of its usual lowered position into a raised position.

In order to allow the pivoting of the plate, a hinge part is provided, which carries the plate, as well as a stationary bearing part, wherein the hinge member is articulated to the stationary bearing. The bearing member may be a part of the bar counter itself or be connected to the counter. A force storage serves as booster help in order to facilitate the lifting of the plate for the operating personnel, wherein the force storage exhibits two connecting ends, which connecting ends are each arranged with a mating terminal end of the articulated part and of the bearing part. Here both the terminal ends as well as the counter-connection ends are formed as parts of ball joints.

A known device of this type is described in the German Patent DE 44 02 727 C1. Two force storage elements serve as a booster help in the subject of the German Patent document, which force storage elements are articulated by means of ball and socket joints on the bearing part and the hinge member. Here, the terminal ends of the energy storage are formed as ball joints, while the ball joints are arranged on the articulated part or on the bearing part. The energy storage elements used in the above-mentioned patent application are typically furnished as gas pressure springs. It may now occur during the operating lifetime of the energy storage that the gas pressure spring loses pressure, for example due to leakage or also when used in very cold ambient temperatures. In this case, the energy storage can no longer carry the weight of the plate in its raised position, and the plate can swing down unintentionally. This can lead to accidents. Further, it may happen that the ball heads of the force storage slip out of the ball sockets, as the ball heads are not further secured in the ball sockets, but the ball heads are supported only by the pressure of the force storage. At a pressure drop, the force storage can then fall into the goods contained in the counter, which can lead to damage or contamination of the goods. Therefore, it is an object of the invention to avoid the aforementioned disadvantages and to provide a device of the kind, wherein the energy storage is safely supported on the bearing part or on the articulated part, and cannot fall out inadvertently. This objective is achieved according to the present invention by the characterizing features of claim 1, which features have the special meaning in the following. At least one of the terminal ends of the force storage is formed as a ball socket, while the associated ball head is formed as a mating terminal end of the articulated part or, respectively, on the bearing part. Furthermore, a securing element is provided, which securing element secures the two parts of at least one ball joint of the respective energy storage when installed and incorporated together. This securing element takes care therefore that the ball head cannot slip out of the ball socket and thus the energy storage falls out, possibly in the displayed goods. A secure support of the energy storage is therefore present.

Furthermore, it is provided that the two connecting ends of the force storage are constructed differently and thus to only one of the connecting ends at the joint ball part or at the bearing part can be brought into mechanical operative connection. This is particularly advantageous when using energy storage elements, which are filled with a liquid, such as a hydraulic oil. In this case a mounting direction is given, which ensures that the sealing gasket furnished at the energy storage is normally always wetted with liquid, so that the sealing gasket does not dry out and become brittle and thus airtight. If the two terminal ends of the energy storage are made of identical construction, then it is possible to incorporate the energy storage reversely, whereby embrittlement of the seal can occur. The energy storage then becomes leaky and unusable and must be replaced. If now the two connection ends provided at the energy storage are furnished differently, then the orientation is predetermined by the counter-terminal ends and an erroneous assembly can be avoided.

An example of such a different form of the terminal ends of the energy storage comprises to furnish one terminal end of the energy storage as a ball socket, and the other terminal end as a ball head. The counter-connection points, which are arranged on the articulated part and on the bearing part, then also each has a respective ball head and a ball socket. During installation of the force storage then the connection point formed as a ball head with the mating counter connection point formed as a ball socket is brought into operative connection and vice versa. Thus the correct arrangement of the force storage is realized on the device.

Another alternative is to form the terminal ends of the energy storage different such that the energy storage device is mounted in the correct direction and comprises that the two terminal ends of the energy storage are furnished as ball sockets and the counter-connection points on the articulation part and on the bearing part are then furnished as ball heads. In order to ensure correct assembly of the force storage, the two then as ball heads formed mating connection points have different diameters, wherein the two connection points serving as ball sockets are each adapted to one of these two diameters. This likewise avoids an erroneous assembly, since in each case only one ball head can be brought in active connection with one ball socket. Preferably piston-like components such as gas pressure cylinders, hydraulic cylinders, gas springs, etc. are used as a force storage.

Further advantages and embodiments will become apparent from the dependent claims, the following description and the drawings. In the figures, the object of the invention is illustrated in two embodiments. There are shown:

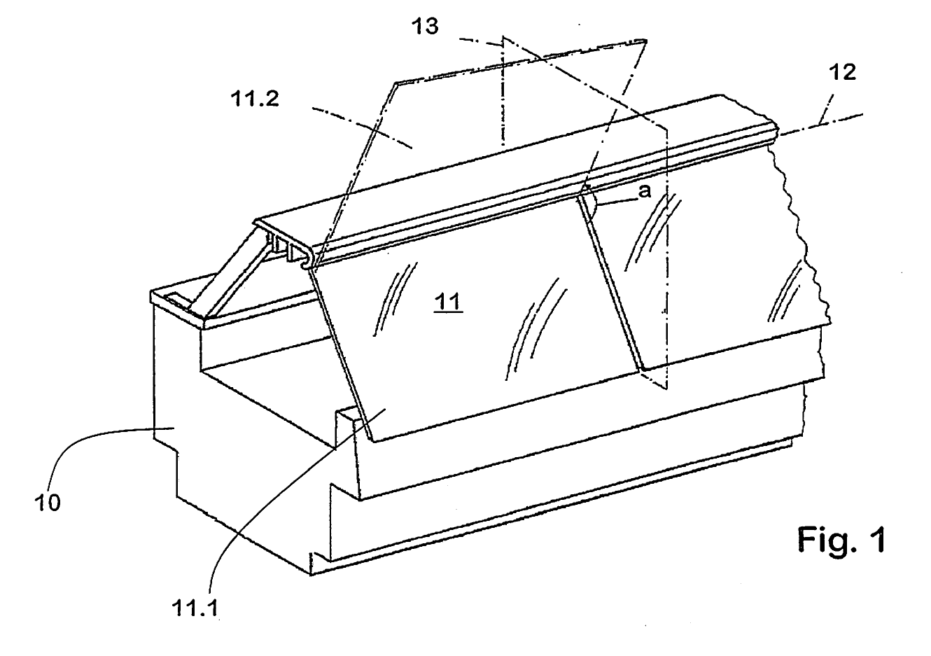

FIG. 1 shows a bar counter with the invention device.

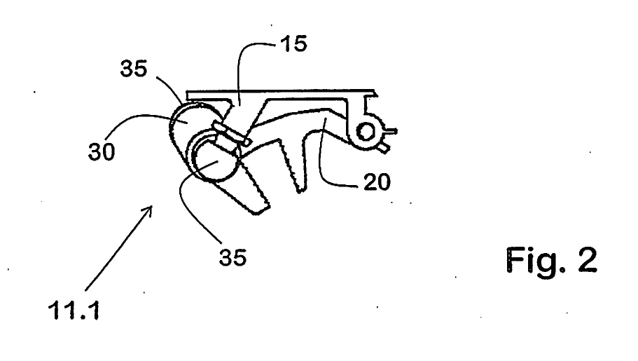

FIG. 2 shows the device of FIG. 4 in a side elevational view.

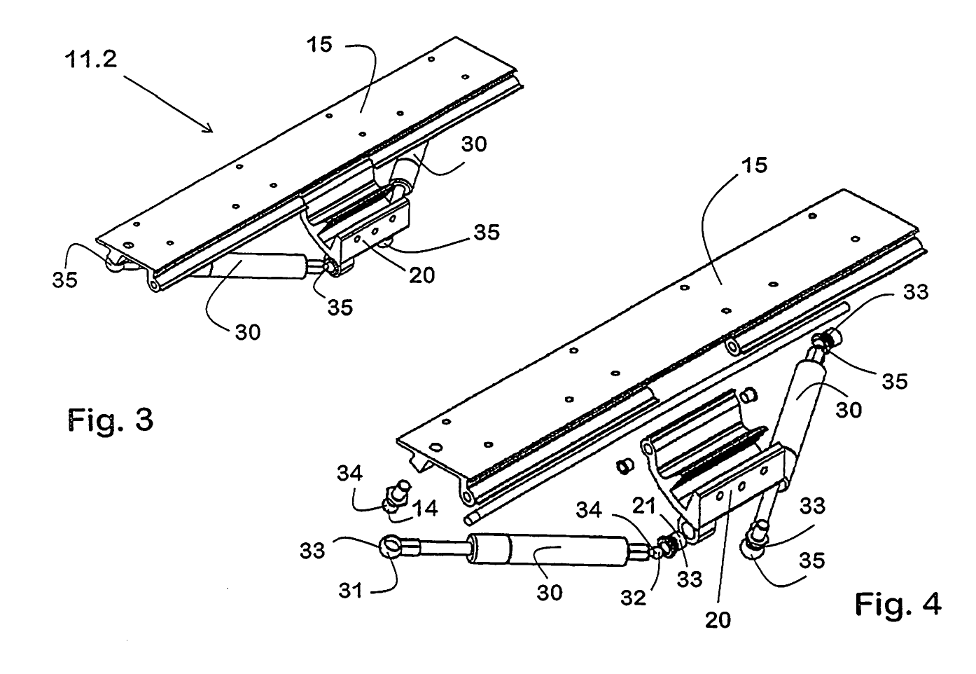

FIG. 3 shows a second embodiment of a device according to the present invention in a view according to FIG. 2.

FIG. 4 shows the device of FIG. 3 in a partly exploded view.

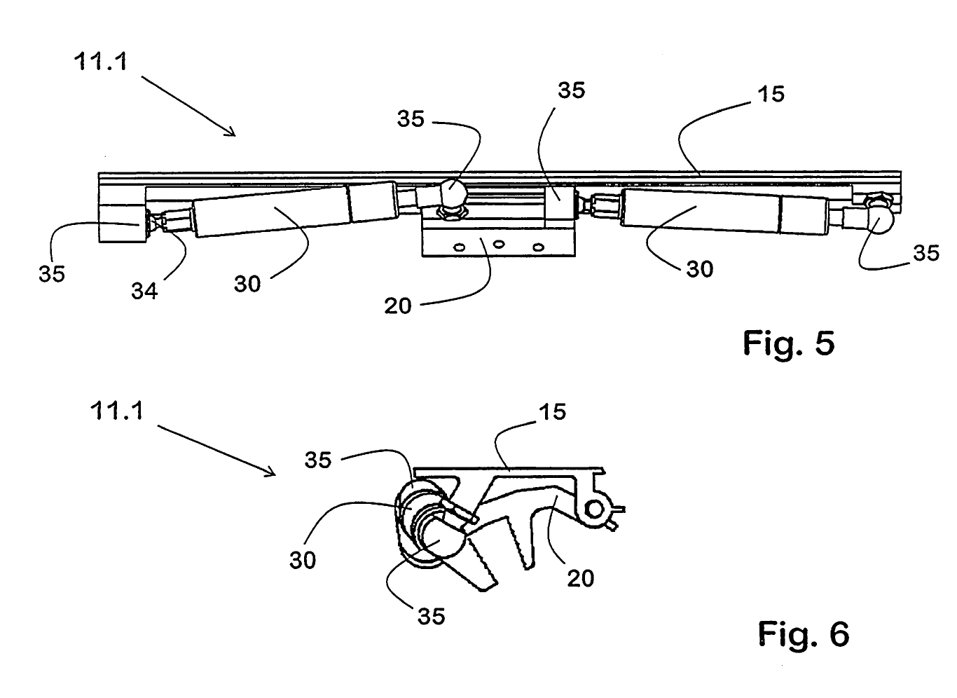

FIG. 5 shows the device of FIG. 4 in a front elevational view in lowered position.

FIG. 6 shows the device according to FIG. 5 in a side according to FIG. 2.

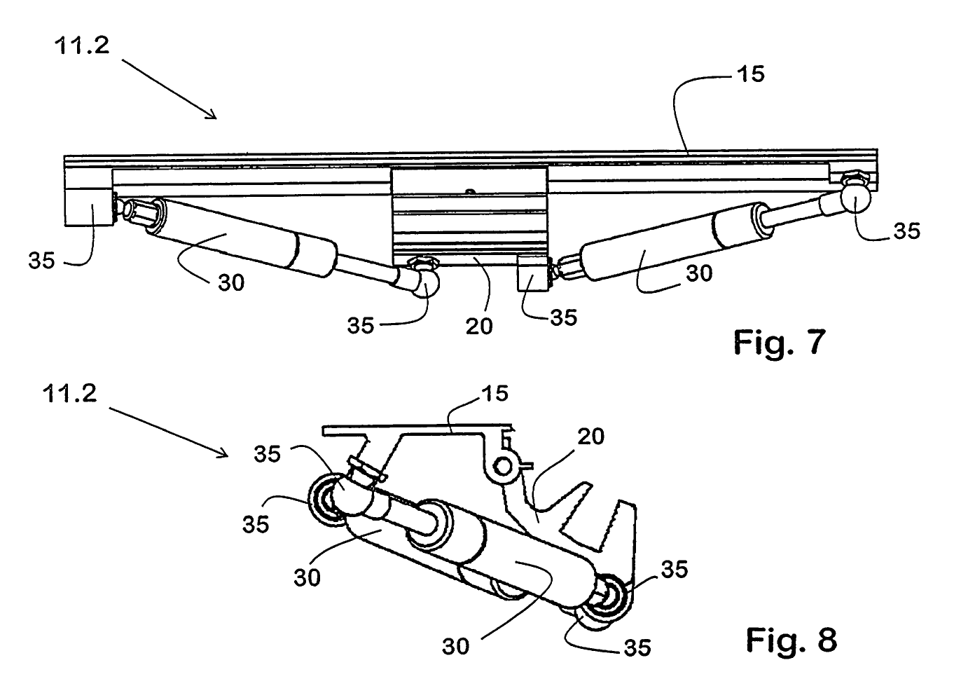

FIG. 7 shows the device of FIG. 3 in a raised position.

FIG. 8 shows the device of FIG. 7 in a side view according to FIG. 4.

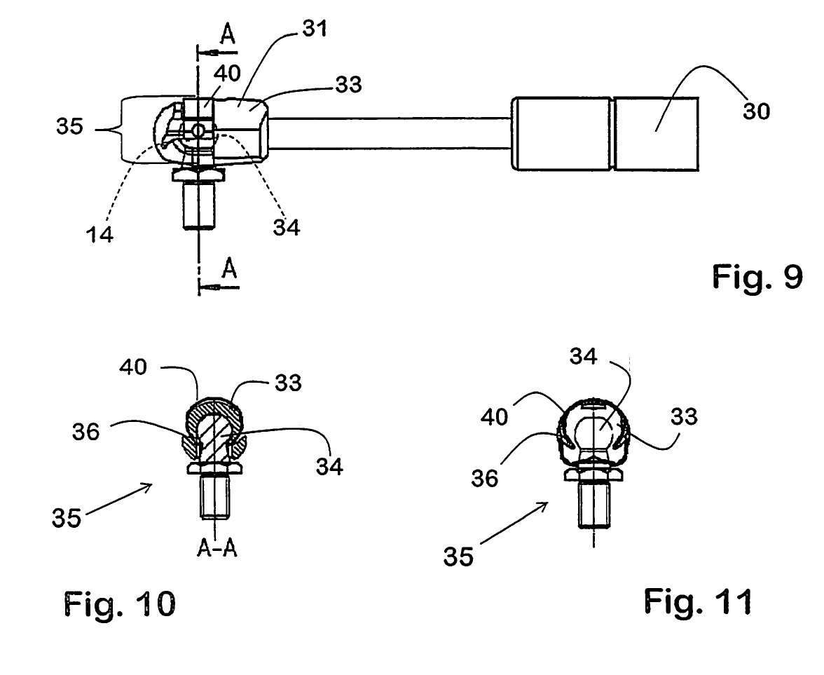

FIG. 9 shows a part of an energy storage with ball joint and securing element.

FIG. 10 shows the ball joint with locking element of FIG. 9 along the section AA.

FIG. 11 shows the ball joint with locking element in a side view.

FIG. 1 shows a counter 10 with a device according to the present invention. The counter 10 has a plate 11, which is normally in its lowered position shown here, 11.1. In this position of the plate 11 customers can look at goods in the bar counter 10, for example. For filling or, respectively, cleaning of the counter 10, the plate 11 can be pivoted along the direction a to its raised position 11.2. The pivoting takes place along the pivot axis 12. The raised position 11.2 is shown with dash-dotted lines. The pivot axis 12 is perpendicular to the pivoting plane 13, in which also the pivotal direction a is located.

FIGS. 2 to 4 show a device of the invention in a first embodiment in one lifting position 11.2 of the first plate 11 not shown here. The holder for the plate 11 not shown here is arranged on the articulated part 20. Furthermore, also the stationary bearing portion 15 is provided, which is fastenable to the counter 10. The device has two power storage elements 30, which power storage elements 30 have two terminal ends 31, 32, which terminal ends 31, 32 together with the counter-terminal ends 14, 21 on the bearing part 15 and the articulated portion 20 form a total of four ball joints. Two force storage elements 30 are employed for each plate 11 according to this embodiment example, which force storage elements 30 are disposed mutually symmetrically with respect to the pivoting plane 13, which is shown in FIG. 1. This has proven to be advantageous, since then the plate 1 can be swiveled particularly simple and can also not be canted or jammed.

FIGS. 5 and 6 show the device according to FIGS. 2 and 3, wherein the plate 11 is not shown here and is disposed in its lowered position 11.1. FIG. 4 is a front elevational view and FIG. 5 is a side view of the invention device.

FIGS. 7 and 8 correspond to the representation to the FIGS. 5 and 6, except that the plate 11 not shown here is disposed in its raised position 11.2. It can be seen that the force storage elements 30 have moved with a pivoting movement a around the pivot axis 12 of the disc 11. Of course the force storage elements are still arranged on the bearing member 15 and the articulated part 20 by way of the ball and socket joints 35. The one connecting end 31 of the power storage element 30 is formed as a ball socket 33 in the embodiment according to FIGS. 2 to 8, while the other terminal end 32 of the energy storage 30 is formed as a ball head 34. As can be recognized in the FIG. 9 in a greater detail representation, a counter-connection end 14 on the bearing part 15 is prepared as a spherical head 34 for cooperation with the one connecting end 31, which is constructed as a ball socket 33. In contrast, the other terminal end 21 is formed at the articulated portion 20 as a ball socket 33 in order to cooperate with the other terminal end 32, which is constructed as a spherical head 34. A connection end 31 formed in each case as a ball socket 33 is disposed once at the articulated portion 20 and once arranged on the bearing part 15 as shown in the figures. Of course, each of the two one terminal ends 31 which are formed as a ball socket 33, can both be disposed on the bearing part 15 or, respectively, at the joint portion 20.

FIGS. 9 to 11 show a type of securing of the spherical head 34 in the ball socket 33 by means of the securing element 40. The one connecting end 31 of the energy storage 30 which is here shown only partially, is constructed as a ball socket 33 and cooperates with the ball head 34, which serves as a first mating counter terminal end 14 at the bearing part 15. Ball socket 33 and ball head 34 form the ball and socket joint 35. These two parts of the ball and socket joint 35 are secured at each other by a securing element 40 formed as a spring. The ball socket 33 here has slot-shaped recesses 36 into which the securing element 40 formed as a spring engages in the mounting case and surrounds the ball head 34 and this way secures the ball head 34 at the ball socket 33.

Finally, it should be noted that the embodiments illustrated herein are exemplary implementations of the invention only. The invention is not limited thereto. Rather, there are still changes and modifications possible. In particular it is also possible to form the locking or securing element differently. The exact form of ball head and ball socket can be performed differently.

### LIST OF REFERENCE NUMERALS

10 bar counter
11 plate
11.1 lowered position
11.2 raised position
12 pivot axis of 11
13 pivotal plane
14 an end of a counter connection
15 bearing part
20 articulated part
21 another end of a counter connection
30 power storage
31 an end of a connection of 30
32 another end of a connection of 30
33 ball socket
34 spherical head
35 ball and socket joint
36 recess
40 securing element

1. Apparatus for pivotal movement of a plate (11), in particular at a bar counter (10), such as a cooling, sales or self service counter,
with a stationary bearing part (15) for a pivotally mounted thereto joint part (20), wherein the plate (11) and a substantially horizontal pivot axis (12),
about which the plate (11) is pivotable between a lowered position (11.1) and a raised position (11.2) in a substantially vertical pivoting plane (13),
and with an energy storage element (30) serving as a lifting help for lifting the plate (11) serving for energy storage (30),
wherein the energy storage element (30) has two terminal ends (31, 32),
and wherein two counter-connection ends (14, 21) are furnished, of which one counter connection end (21) is disposed co-movable on the joint part (20) and the other counter connection end (14) is fixedly arranged on the bearing part (15), wherein the connecting ends (31, 32) and the counter-connection ends (14, 21) are formed as parts of ball and socket joints (35),
characterized in
that at least one of the connecting ends (31, 32) of an energy storage (30) is formed as a ball socket (33), while the counter connection end (14, 21) disposed at the joint part (20) or, respectively, at the bearing part (15) is formed as a spherical head (34)
that the two connecting ends (31, 32) of an energy storage (30) are constructed differently, and only with one of the counter-connection ends (14, 21) on the joint part (20) or on the bearing part (15) can be brought in mechanical operative connection,
and
that a securing element (40) is furnished, which securing element (40) secures two parts (33, 34) of at least one ball and socket joint (35) including a ball socket (33) and a ball head (34), of the respective force storage (30), at each other in an incorporated state.

2. Apparatus according to claim 1, characterized in that said one connecting end (31) of the force storage (30) is a ball socket (33) and the other (32) is a spherical head (34) are formed and one ball head (34) and one ball socket (33) are used as counter-connection points (14, 21) which are arranged on the joint part (20) or on the bearing part (15), wherein during the assembly respectively a ball head (34) with a ball socket (33) can be brought into mechanical operative connection.

3. Apparatus according to claim 1, characterized in that the two connecting ends (31,32) of the force storage (30) are formed as ball sockets (33) and in each case one ball head (34) as a counter-connection point (14, 21) is disposed on the joint part (20) and arranged on the bearing part (15), and
that the two spherical heads (34) serving as counter connection points (14, 21) have different diameters, and the two ball sockets formed as connection points (31, 32) are adapted in each case to one of these two diameters.

4. Apparatus according to claim 1, characterized in that the securing element (40) is a spring which at least partially encompasses both the ball head (34) and the ball socket (33) and this way secures the ball and socket joint (35) in the mounted state.

5. Apparatus according to claim 4, characterized in that the ball socket (33) has one or more slot-shaped recesses (36) through which the securing element (40) can be guided to secure the ball head (34) to the ball socket (33).

6. Apparatus according to claim 1, characterized in that two power storages (30) are used for each plate (11), wherein the two power storages are disposed mirror symmetrical relative to the pivot plane (13) of the plate (11).

7. Apparatus according to claim 1, characterized in that piston-like components, such as hydraulic cylinders, gas springs or gas pressure cylinders serve as force storage (30).

8. (canceled)

9. (canceled)
